(19) United States
(12) Patent Application Publication
(10) Pub. No.: US 2005/0045277 A1
(43) Pub. Date: Mar. 3, 2005

(54) Structure for coupling a coating film transfer tool with stationery

(75) Inventors: Kazuhiro Tanaka, Osaka-shi (JP); Tomio Kaneda, Osaka-shi (JP); Hiroshi Kozaki, Osaka-shi (JP)

Correspondence Address: HOWSON AND HOWSON;ONE SPRING HOUSE CORPORATION CENTER, BOX 457, 321 NORRISTOWN ROAD, SPRING HOUSE, PA, 19477, US

(73) Assignee: c/o Fujicopian Co., Ltd., Osaka-shi (JP)

(21) Appl. No.: 10/928,845

(22) Filed: Aug. 27, 2004

(30) Foreign Application Priority Data
Aug. 29, 2003 (JP) 2003-306739

(51) Int. Cl. B32B 31/00; B05C 1/00

(52) U.S. Cl. 156/540; 156/574; 156/579; 118/200; 156/577; 118/257

(57) ABSTRACT

A combined coating film transfer tool and article of stationery comprises a member formed on an end of a coating film transfer tool and another member formed on an end of stationery article. One of the members is in the shape of a shaft and the other is in the shape of a bore. The two members have cooperatively fitting parts at least one of which is elastically deformable.

### FIELD OF THE INVENTION

This invention relates to a structure for coupling a coating film transfer tool with an article of stationery such as a writing implement.

### BACKGROUND OF THE INVENTION

Coating film transfer tools are used for transferring a film onto a receiving surface. Such tools may be used for the transfer of a correction film, an adhesive film, a decorative film, etc. It is common for a coating film transfer tool to be removably integrated with a ball-point pen or other article of stationery, so that the coating film transfer tool can be replaced.

For example, FIG. 6 depicts a combination writing instrument and coating film transfer tool disclosed in unexamined Japanese Patent Publication No. 25056/1998. The device comprises an elongated case 61, divided into two parts at an intermediate location along the longitudinal direction. A transfer head 64 is provided for pressing a transfer tape T against a receiving surface (not shown) so that a material such as an adhesive or a correcting coating, laminated onto the tape, can be transferred to the receiving surface.

The case 61 comprises case elements 61A and 61B, each case element comprising two plate-shaped members which are fitted to each other. The case elements 61A and 61B are removably coupled by a joint member 66, having oppositely facing recesses which receive end projections on the respective case elements.

The case element 61A functions as a coating film transfer tool, and the case element 61B, being equipped with a pen point 68, functions as a writing instrument. A removable protective cap 69 covers the pen point 68.

FIG. 7 shows another combination writing instrument and coating film transfer tool 70, disclosed in unexamined Japanese Patent Publication No. 181288/1998. The device comprises a pen section 72 and a coating film transfer tool 73 on opposite sides of a tubular coupling 71. A projection on the coating film transfer tool 73 fits removably into a hole formed in the coupling 71.

When a used transfer tool is removed in the process of replacement, the joint member can accidentally come off the article of stationery together with the transfer tool. In such a case, it is difficult for users to couple a new coating film transfer tool with the article of stationery. In addition, the device requires another component in addition to the transfer tool and the article of stationery.

To address the above-mentioned problems, a combined coating film transfer tool and writing implement 80, as shown in FIG. 8, has been provided, in which the transfer tool 82 and the writing implement 84 are directly and removably coupled. The coating film transfer tool 82 is provided with a shaft-shaped member 86 which is integrally formed on the end of the transfer tool, and a bore-shaped member 88 is integrally formed on an end of the writing implement. These members 86 and 88 can comprise screw threads as shown for example in FIG. 9 and described in unexamined Japanese Patent Publication No. 511265/2003. Alternatively, the members can comprise projections and recesses as shown in FIG. 10. In the case where the members have projections and recesses, coupling is achieved by fitting the projections and the recesses of the members 86 and 88 into each other.

The article of stationery 84 and the coating film transfer tool 82 can be integrated simply by fitting the member 86 on the coating film transfer tool 82 into the member 88 on the article of stationery 84, without a separate, intermediate, joint member. A used coating film transfer tool can be removed from the article of stationery and replaced by a new coating film transfer tool by securely mounting the new coating film transfer tool directly onto the article of stationery. However, when the members 86 and 88 comprise screw threads as shown in FIG. 9, it is necessary to rotate one element relative to the other in order to engage or disengage the threads. In addition, the structure of the mold for forming the product is complicated, and the production of the product is time-consuming and labor-intensive.

On the other hand, when the members 86 and 88 comprise the projections and recesses as shown in FIG. 10, the insertion force encountered during assembly, and the ability of the joint to hold the two elements together, tend to vary. The variation in the insertion force and in the holding capability of the joint is due to changes in the dimensions of the members 86 and 88. Therefore, close control of dimensions is required, and accurate processing is necessary, causing production to be time-consuming and labor-intensive.

In view of the above-mentioned problems, the object of the invention is to provide a structure for coupling a coating film transfer tool with an article of stationery, wherein connection and removal can be achieved easily; fluctuations of load, both at the time of insertion and after integration, is small even when the dimensions of the members vary; and production can be achieved in short period of time and at low cost.

### SUMMARY OF THE INVENTION

The combination coating film transfer tool and article of stationery in accordance with the invention comprises a first member formed as an integral part on one end of the coating film transfer tool and a second member formed as an integral part on one end of the article of stationery. One of the two members is in the shape of a shaft and the other member is in the shape of a bore. The member in the shape of a shaft is received in the member in the shape of a bore. The members have cooperatively fitting parts resisting separation of the members, and at least one of the cooperatively fitting parts is elastically deformable, whereby the members can be separated by elastic deformation of at least one of said cooperatively fitting parts.

The cooperatively fitting parts may comprise a circumferential projection, comprising an elastic body, formed on one of the members and a circumferential recess formed in the other member. In one case the circumferential projection and the circumferential recess are both continuous, i.e., annular in form. In another case, a part of one of the members has a slot and is elastically deformable.

In another embodiment, the cooperatively fitting parts comprise a pin on one member, a pin-hole on the other member for receiving the pin, and a slot formed in the member having the pin hole and extending from the pin-hole to an end of the member to permit entry of the pin into the pin-hole shaft is received in the bore.

In still another embodiment, a pin hole is formed in the member having the shape of a bore, and a pin is formed on the other member, the pin fitting into the pin-hole. Slots are formed on both sides of the pin-hole, and at least the part in which the pin hole is formed is elastically deformable so that the pin can be released from the pin-hole.

In still another embodiment, the cooperatively fitting parts comprise a combination of a projection on one member and a receiver on the other member, and slots formed on both sides of the receiver.

According to the invention, since a part of at least one of the two members is elastically deformable, fluctuations in the force exerted on the members as they are connected is kept small, as is the force required to disconnect one member from the other. Therefore, the two members can be easily connected to, and disconnected from, each other. Moreover, because of the elastic deformability of at least one of the parts, close control of the dimensions of the parts is not required in the manufacturing process. Accordingly, a combination coating film transfer tool and article of stationery can be produced in a short period of time and at low cost.

### BRIEF DESCRIPTION OF THE DRAWINGS

FIG. 1 is a schematic exploded view of a structure for coupling a coating film transfer tool with an article of stationery, according to a first embodiment of the invention;

FIG. 2 is a schematic exploded view of a structure for coupling a coating film transfer tool with an article of stationery, according to a second embodiment of the invention;

FIG. 3 is a schematic view of a partially assembled structure for coupling a coating film transfer tool with an article of stationery, according to a third embodiment of the invention;

FIG. 4 is a schematic view of a partially assembled structure for coupling a coating film transfer tool with an article of stationery, according to a fourth embodiment of the invention;

FIG. 5 is a schematic view of a partially assembled structure for coupling a coating film transfer tool with an article of stationery, according to a fifth embodiment of the invention;

FIG. 6 is a schematic sectional view of a conventional coating film transfer tool coupled integral with an article of stationery;

FIG. 7 is an elevational view of another conventional coating film transfer tool coupled with an article of stationery;

FIG. 8 is a schematic sectional view of a further conventional coating film transfer tool coupled with an article of stationery;

FIG. 9 is an exploded schematic view, partly in section, of a device similar to that of FIG. 8, wherein screw threads are provided to connect the respective parts; and

FIG. 9 is an exploded schematic view, partly in section, of another device similar to that of FIG. 8, wherein projections and recesses are provided to connect the respective parts.

### DETAILED DESCRIPTION OF THE PREFERRED EMBODIMENTS

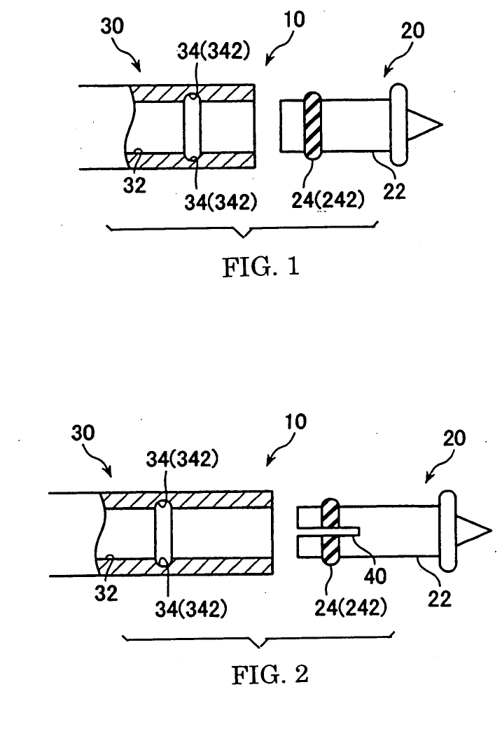

Embodiments of a structure for coupling a coating film transfer tool with an article of stationery according to the invention will be explained referring to FIGS. 1-5. In each case, a coating film transfer tool 20 is coupled with an article of stationery 30 by a pair of cooperating installation members. The cooperating members are constituted by a member 22, formed as an integral part on an end of the coating film transfer tool 20 and a member 32 formed as an integral part on an end of the article of stationery 30. Preferably the member 22 is molded as a unit with the transfer tool, and the member 32 is molded as a unit with the article of stationery. The members 22 and 32 are formed in such a way that one of them is in the shape of a shaft, and the other is in a shape of a bore. The members 22 and 32 comprise cooperatively fitting parts 24 and 34, respectively, at least one of which is elastically deformable so that the members can be connected to each other in such a way as to resist separation. The cooperatively fitting parts 24 and 34, provided on members 22 and 32 can take any of various forms. For example, the fitting parts can comprise a combination of a circumferential projection and a circumferential recess, a combination of a pin and a pin hole, or a combination of a projection and a receiver.

The cooperatively fitting parts 24 and 34 of the members can comprise elastic materials, or a slot can be provided in one or both of the members 22 and 32 so that the members themselves are made elastically deformable.

In the coupling structure of FIG. 1, part 24 is in the form of an annular, circumferential, projection 242 on a shaft-shaped member 22 of the coating film transfer tool 20. The projection 242 preferably comprises a deformable elastomeric body such as a rubber O-ring. Its cooperating part 34 is in the form of an annular, circumferential, recess 342 formed in a bore in member 32.

The second embodiment of the invention, shown in FIG. 2, is nearly identical to the first embodiment, except that a slot 40 is provided so that the part of member 22 where projection 242 is provided is elastically deformable. The slot can extend through the projection 242 so that the projection is in two parts, as shown, or, alternatively, the projection 242 can be in the form of a continuous O-ring as in case of FIG. 1.

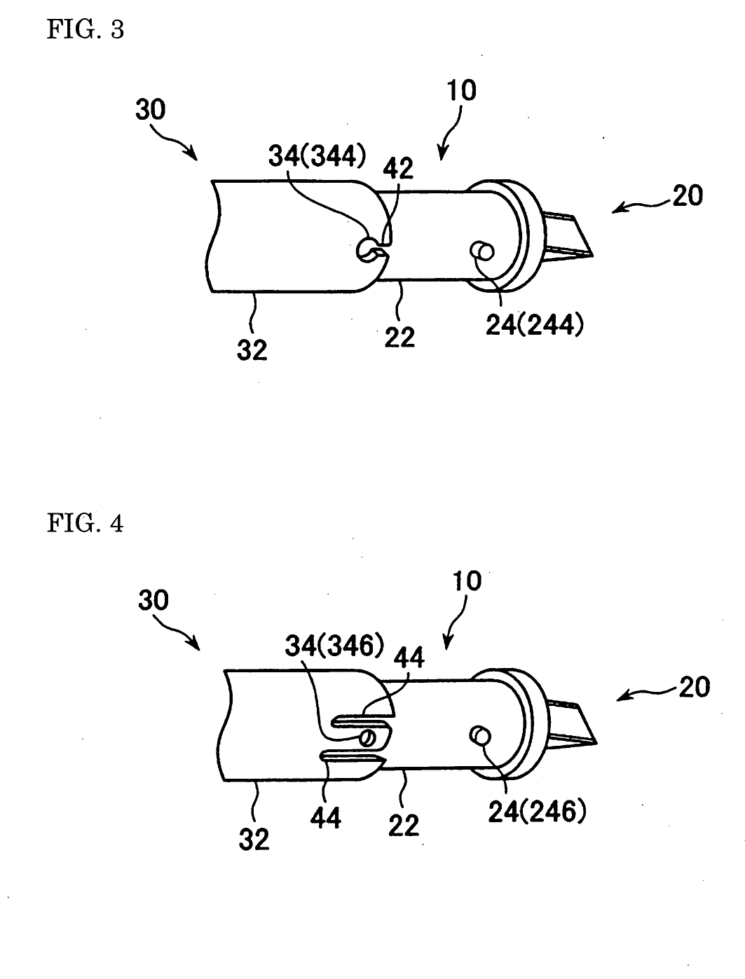

In the third embodiment of the invention, as shown in FIG. 3, the coupling structure comprises a pin 244, formed on a shaft-shaped member 22 of a coating film transfer tool 20, and a pin-hole 344, formed on a bore-shaped member 32 of the article of stationery 30. A slot 42, extending from the pin-hole 344 of the opening at the end of member 32 provides the pin-hole 344 with an elastically deformable entrance for receiving the pin 244.

In the fourth embodiment of the invention, shown in FIG. 4, the coupling structure also comprises a pin and a pin-hole. A pin 246 is formed on a shaft-shaped member 22 of a coating film transfer tool 20, and a pin-hole 346 is formed in a bore-shaped member 32 of the article of stationery 30. The pin and pin hole both extend laterally with respect to the direction in which the two members 22 and 32 are moved when connected to, and disconnected from, each other. Slots 44, on both sides of the pin-hole 346, extend longitudinally to the opening of the bore of member 32, so that a part of member 32 where the pin-hole 346 is provided is elastically deformable.

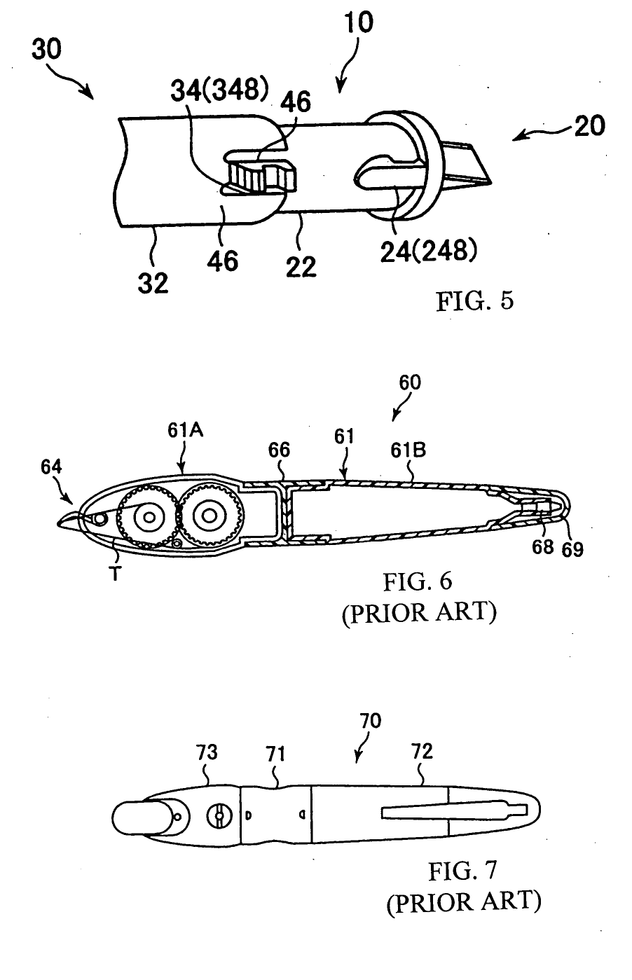

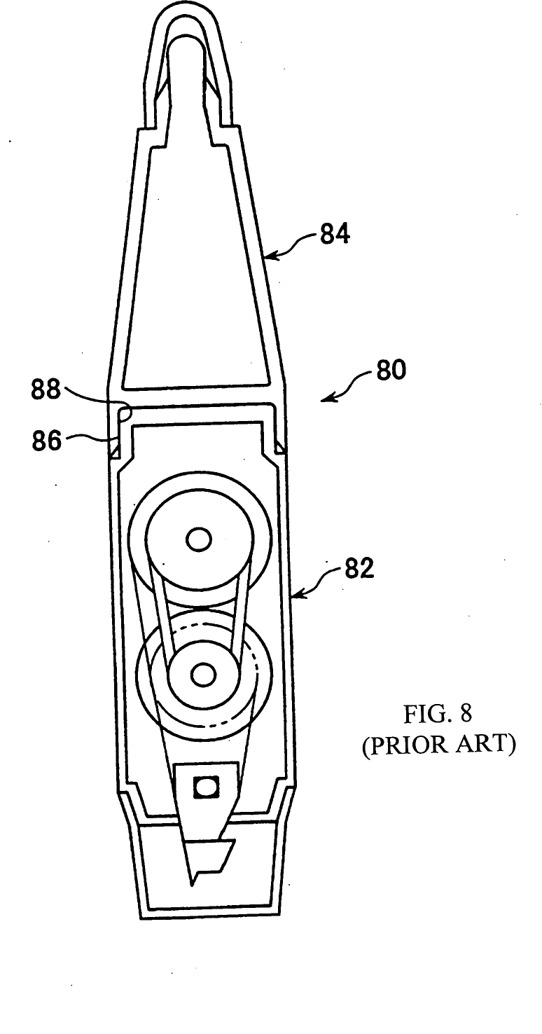

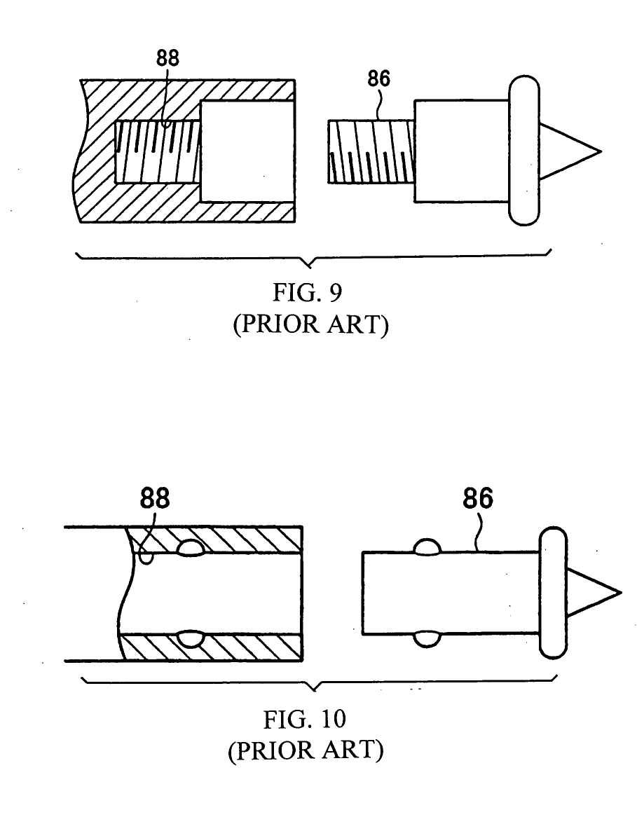

In the fifth embodiment of the invention, as shown in FIG. 5, the coupling structure comprises a nail-like projection 248 extending longitudinally rearwardly alongside the shaft-shaped member 22 of the coating film transfer tool 20, and an elastically deformable receiver 348 formed on the bore-shaped member 32 of the article of stationery 30. Projection 248 has a ramp-shaped tip. Longitudinal slots 46, similar to the slots 44 in FIG. 4, are provided on both sides of the receiver 348 so that the receiver 348 can deform in the lateral direction for connection to, and release from, the projection 248.

In each of the first, second and third embodiments, the coupling structure holds the coating film transfer tool and article of stationery together by a snap-fit which can be overcome by the application of a sufficient pulling force. In the case of the fourth and fifth embodiments, a latching action secures the transfer tool and article of stationery together. In the case of the fourth embodiment, as shown in FIG. 4, manipulation of the part having the pin-hole 346 is required both for attachment and release of the pin 246 from the pin-hole. In the case of the fifth embodiment, as shown in FIG. 5, attachment of the projection 248 with the receiver 348 occurs automatically as the members 22 and 32 are pushed together, as a result of the ramp-like shape of the tip of projection 24. However, manipulation of the receiver, or of the projection, is required in order to release the connection between the transfer tool and the article of stationery. In each of the fourth and fifth embodiments, however, the interlocking elements can be shaped so that the members can be attached and detached by the application of pushing and pulling forces, without manipulation of latching elements.

Although in each of the coupling structures described, a shaft-shaped member is provided on a coating film transfer tool and a bore-shaped member is provided on the article of stationery, the invention is not limited to this arrangement, and as an alternative a bore-shaped member can be provided on the coating film transfer tool and a shaft-shaped member can be provided on the article of stationery. Likewise, in the case of the fourth embodiment as shown in FIG. 4, the pin hole can be provided in member 22 and the pin can be an inwardly directed pin formed on member 32. In the case of the fifth embodiment, projection 248 and receiver 348 can be interchanged. Various other modifications within the scope of the invention will be apparent to those skilled in the art from the description of the embodiments herein.

The article of stationery is, of course, not limited to a writing implement such as a ball-point pen, and can be any of various other generally used articles of stationery such as a glue stick, an eraser, or a seal.

Since a fitting part of at least one of the two members 22 and 32 is elastically deformable, fluctuations in the load at the time of insertion, and the force required to release the connected members, can be kept small, and are not greatly affected by dimensional changes in the members 22 and 32. Close control of the dimensions of the members is not required, and consequently, a combination coating film transfer tool and article of stationery can be produced quickly and at a lower cost. Moreover, since connection and disconnection of the members is achieved by without the use of a screw mechanism, attachment and removal of the transfer tool from the article of stationery can be achieved easily.

1. A combination coating film transfer tool and article of stationery comprising a first member formed as an integral part on one end of said coating film transfer tool and a second member formed as an integral part on one end of said article of stationery, wherein one of said members is in the shape of a shaft and the other of said members is in the shape of a bore, said member in the shape of a shaft is received in said member in the shape of a bore, and said members have cooperatively fitting parts resisting separation of said members, at least one of said cooperatively fitting parts being elastically deformable, whereby the members can be separated by elastic deformation of said at least one of said cooperatively fitting parts.

2. A combination coating film transfer tool and article of stationery according to claim 1, wherein said cooperatively fitting parts comprise an annular, circumferential, projection formed on one of said members and an annular, circumferential, recess formed in the other of said members, said projection comprising an elastic body.

3. A combination coating film transfer tool and article of stationery according to claim 1, wherein said cooperatively fitting parts comprise a circumferential projection formed on one of said members and a circumferential recess formed in the other of said members, and a slot formed in one of said members, at least the part of said one of said members in which the slot is formed being elastically deformable.

4. A combination coating film transfer tool and article of stationery according to claim 1, wherein said cooperatively fitting parts comprise a pin on one of said members, a pin-hole on the other of said members for receiving said pin, and a slot formed in said other of said members, said slot extending from said pin-hole to an end of said other of said members, said slot permitting entry of said pin into said pin-hole as said member in the shape of a shaft is received in said member in the shape of a bore.

5. A combination coating film transfer tool and article of stationery according to claim 1, wherein said cooperatively fitting parts comprise a pin hole formed in the one of said members in the shape of a bore, and a pin formed on the other of said members, said pin fitting into said pin-hole, and slots formed on both sides of said pin-hole, at least the part of said one of said members in the shape of a bore being elastically deformable, whereby the pin can be released from the pin-hole.

6. A combination coating film transfer tool and article of stationery according to claim 1, wherein said cooperatively fitting parts comprise a combination of a projection on one of said members and a receiver on the other of said members.

7. A combination coating film transfer tool and article of stationery according to claim 1, wherein said cooperatively fitting parts comprise a combination of a projection on one of said members and a receiver on the other of said members, and slots formed on both sides of one of said cooperatively fitting parts.

8. A combination coating film transfer tool and article of stationery according to claim 1, wherein said cooperatively fitting parts comprise a combination of a projection on one of said members and a receiver on the other of said members, and slots formed on both sides of said receiver.
